(19) United States
(12) Patent Application Publication
(10) Pub. No.: US 2018/0165720 A1
(43) Pub. Date: Jun. 14, 2018

(54) Methods And Systems For Connecting Innovators To Researchers And Money Sources To Facilitate The Development Of Science

(71) Applicant: JASON BARKELOO, COVINGTON, KY (US)

(72) Inventor: JASON BARKELOO, COVINGTON, KY (US)

(21) Appl. No.: 15/837,134

(22) Filed: Dec. 11, 2017

Related U.S. Application Data
(60) Provisional application No. 62/432,315, filed on Dec. 9, 2016.

(51) Int. Cl. G06Q 30/02; G06F 3/0481

(52) U.S. Cl. CPC G06Q 30/0279; G06F 3/0481

(57) ABSTRACT

Disclosed herein are systems and methods to create an open system for the disclosure and development of technologies. Innovators and/or brands having technologies may upload technology disclosures to system components. Source(s) of monetary funding may view the technology disclosures and decide to fund research and development of one or more technologies. Source(s) of monetary funding may include individuals, and the system may be operated in part as a crowdfunding platform. Disclosures of the technologies may be formatted as grant applications or submissions in response to a request for proposals. One or more researchers may access the disclosures of the technologies, the innovators, and/or the brands to collaborate in the development of the technologies. The researchers may include one or more individuals having a doctoral degree. This collaboration may result in the generation of manuscripts, and the manuscripts may become pre-peer reviewed articles available for publication by a journal.

### CROSS-REFERENCE TO RELATED APPLICATIONS

This application claims priority to U.S. Provisional Application No. 62/432,315, entitled “METHODS AND SYSTEMS FOR CONNECTING INNOVATORS TO RESEARCHERS AND MONEY SOURCES TO FACILITATE THE DEVELOPMENT OF SCIENCE,” filed on Dec. 9, 2016, the entirety of which is hereby incorporated by reference.

### BACKGROUND

The Oxford English Dictionary defines science as a “branch of study that deals with a connected body of demonstrated truths or with observed facts systematically classified and more or less comprehended by general laws, and incorporating trustworthy methods . . . for the discovery of new truth in its own domain.” The scientific method generally includes making observations, formulating hypotheses about the causes or roots of the observations, experimenting to gather data to test the hypotheses, and developing general theories based on the gathered data. Many scientists are driven by, and find purpose in, expanding the body of human knowledge. Consistent with this end, many scientists aim to publish their findings for dissemination to the broader scientific community. Other scientists can then independently test and/or expand on the published findings, creating new publications of their own. Scientific publications accordingly record and disseminate new knowledge, allowing the aggregate of human knowledge to incrementally expand. Many entities attempt to patent scientific and technical developments. In many fields, however, legal and social developments have incentivized decisions to make scientific and technical developments open-sourced.

In recent years, crowdfunding websites have emerged to fund particular projects or ventures. Generally, crowdfunding may refer to funding projects and ventures by a large number of individual donors, particularly where the amount of each individual donation is relatively small. Crowdfunding has allowed entrepreneurs to obtain enough capital to launch new products and services in the market. Crowdfunding websites may allow a user with an idea to post a description of the idea to the website, where other users can browse the posts and choose to fund particular projects with individual, often small, donations. Crowdfunding donors are often moved to donate money because of a personal experience or to see whether a perceived good idea can perform well in the market. For example, the son of a woman who passed of breast cancer may be moved to donate a small amount of money to a crowdfunded event to spread breast cancer awareness. Another person may donate a small amount of money purely because he or she thinks that an innovator has a potentially successful idea or product.

Many individuals, groups, foundations, institutions, and other entities having money actively look for ways to fund promising scientific research. For example, a non-profit organization may be founded by parents who lost a child to a rare, little-researched disease for the purpose of raising money and funding research directed to an eventual cure of the disease. There exists a gap between such organizations—particularly relatively unsophisticated organizations—and researchers looking for funding to conduct the same research.

Aside from a personal, intrinsic value of generating new knowledge, many scientists are motivated to publish by other factors. For example, having one's work published can obtain, sustain, and advance a career. The number, frequency, and quality of publications can impact a scientist's prestige within the scientific community. A metric known as the h-index (also called the h-factor or h-value) is often used to measure the productivity and citation impact of the publications of a scientist; accordingly, a scientist with a large h-value may have a significant amount of prestige and influence in the scientific community.

A number of scientific and technical journals exist today to publish results of scientific efforts and disseminate the publications to the rest of the scientific community. Most of the well-respected journals, however, include strict requirements for publication, often including scholarly peer review. Generally speaking, the peer review process involves the evaluation of work by one or more persons having similar competence as the author to maintain quality, improve performance, and provide credibility. Peer review may aid a journal editor in determining whether to publish a paper, publish a paper with revisions, or reject a paper.

One common criticism of the publication process, particularly among the authors in the scientific community, is the amount of time and effort required to produce a publication-ready manuscript. Journals may also spend significant amounts of time and effort reviewing submitted manuscripts to determine which manuscripts to publish, especially during the peer review process. As a result, it may take a journal a year or more to publish a manuscript after its initial submission. Even highly prolific authors may only produce a handful of publishable articles in a year. This time delay is especially concerning for scientists who author potentially publication-worthy manuscripts, but a particular journal decides not to publish the manuscript as an article. The time delays inherent in the current publication process can retard scientists' careers and delay the dissemination of potentially important scientific information. Even when a manuscript is published in a journal, the journal may have a narrow readership limited to those in a narrow scientific field, thus limiting the cross-disciplinary sharing of scientific information. Another limitation in the present scientific process is the availability of money to fund the initial research and experimentation that lays the foundation for eventual manuscripts.

Accordingly, there is a need to improve the processes by which a scientist's work can be disseminated without sacrificing quality. There is additionally a need to match potential sources of monetary funding with researchers.

### SUMMARY

The systems and methods of the present disclosure may combine at least three important elements: innovators, technologies developed by innovators, and sources of monetary funding. Innovators may include scientists, inventors, and those with ideas to advance science and technology and the will to work to develop those ideas. Innovators may strive to further the advancement of science in one or more fields and, in the process of that advancement, develop technologies. Even purely self-interested innovators, i.e., those innovators motivated by money, career advancement, or prestige, may contribute to the development of new technologies, as one of the surest ways to accumulate wealth, promotions, or prestige in the sciences and technical fields is to generate scientific and technical innovations. Thus, even purely self-interested scientists and technologists develop technologies.

“Technologies,” as used herein, may include ideas related to and the subjects of research in one or more scientific or technical fields. A technology may include a project idea that, after research and/or experimentation, may become the subject of a manuscript and perhaps a journal article. A technology may also include an idea that, after research and experimentation, may become a marketable product or service, such as a new or improved medical treatment. Technologies may include the fruits of human ingenuity and labor but may also include discoveries of previously unknown natural phenomena. Technologies may be the subject of research, work, or discovery undertaken by an innovator. Some technologies may be well developed, while other technologies may be ideas for research. As is well-known in the scientific and technical fields, external sources of funding may be critical toward research and development directed toward a particular technology.

Sources of monetary funding may refer broadly to people, entities, governments, and others who provide money. Sources of monetary funding may include requests for proposals; grants; science, technology, and innovation policies of institutions that provide incentives for research; foundations; philanthropies; and the like. Often, these sources of funding may require an innovator to apply or pitch a technology to fund research and development to further that technology. Filling out several applications may be time consuming for the innovator, side-tracking the innovator from actually conducting the research. This process may also be time consuming for the sources of monetary funding, who may have to wade through many irrelevant and/or inadequate applications for funding that may not be directed toward the source's target area for funding. For example, a foundation may support research to combat breast cancer but may receive funding applications from those studying lymphoma or rheumatoid arthritis.

Sources of monetary funding may also include individuals. For example, many individuals may be generally interested in the advancement of science and technology, and others may feel passionate about a particular area of research. Continuing with the breast cancer example, family and friends who have recently lost a loved one to breast cancer may feel the need to support research in the areas of diagnosing and treating breast cancer. Often, individuals may be disconnected to existing entities that fund research. A drawback to funding entities that in turn fund specific research is that the donors cannot often trace their money to specific research projects, and many entities have significant overhead costs. The success of crowdfunding platforms has demonstrated the power to accumulate a large quantity of small donations by showing the individual donors exactly what the idea is and what the donations will go toward. There is presently a disconnect between potential individual donors and researchers in scientific and technological fields.

In addition to innovators, technologies developed by innovators, and sources of monetary funding, systems and methods of the present disclosure may include another element as part of the combination: brands. A “brand” may refer to an institution, such as a hospital, university, for-profit company, research institute, and the like. An innovator may be associated with, such as employed by, a particular brand. For example, a prolific innovator may be associated with a particularly prestigious research hospital. The association of the innovator may, implicitly or expressly, bring with it the association of the brand, and vice versa. A brand may bring along with it its goodwill, such as a level of prestige, and/or may contribute money as a source of monetary funding. A brand may also bring researchers and/or other innovators working in a number of technological areas.

These elements—innovators, technologies, sources of monetary funding, and brands—may each contribute some aspect to scientific and technical research: an idea, work or labor, money, credibility, and more. Many of these elements have the same or overlapping goals, such as seeing particular research have success and a positive impact. However, many of these elements, despite similar or common goals, never meet to combine into potentially fruitful partnerships. The systems and methods described herein may attempt to facilitate a connection among those elements having overlapping goals, ideals, or other common aspects to allow funding to find promising avenues for research.

### BRIEF DESCRIPTION OF THE DRAWINGS

The foregoing and other features of the present disclosure will become more fully apparent from the following description and appended claims, taken in conjunction with the accompanying drawings. Understanding that these drawings depict several examples in accordance with the disclosure and are, therefore, not to be considered limiting of its scope, the disclosure is described with additional specificity and detail below through the use of the accompanying drawings.

In the drawings:

FIG. 1 is a schematic diagram that illustrates a back-end server in accordance with an exemplary embodiment of the present disclosure;

FIG. 2 is a diagram that illustrates a crowdfunding capability of an exemplary embodiment of the present disclosure;

FIG. 3 is a diagram that illustrates how an innovator and one or more researchers may access a user interface to collaborate on a research and development project for a technology according to an exemplary embodiment of the present disclosure;

FIG. 4 is a diagram illustrating an exemplary embodiment that includes one or more science community managers;

FIG. 5 is a flowchart illustrating an exemplary embodiment of a method according to the present disclosure;

FIG. 6 is a flowchart illustrating an exemplary embodiment of a method according to the present disclosure;

FIG. 7 is a flowchart illustrating an exemplary embodiment of a method according to the present disclosure; and

FIG. 8 shows a conceptualization of an embodiment of systems and methods of the present disclosure.

### DETAILED DESCRIPTION

In the following detailed description, reference is made to the accompanying drawings, which form a part hereof. In the drawings, similar symbols identify similar components, unless context dictates otherwise. The illustrative examples described in the detailed description and drawings are not meant to be limiting and are for explanatory purposes. Other examples may be utilized, and other changes may be made, without departing from the spirit or scope of the subject matter presented herein. It will be readily understood that the aspects of the present disclosure, as generally described herein and illustrated in the drawings, may be arranged, substituted, combined, and designed in a wide variety of different configurations, each of which are explicitly contemplated and made part of this disclosure.

This disclosure is generally drawn to methods and systems related to the funding and publication of scientific research. More specifically, this disclosure is drawn to methods and systems for connecting innovators and scientists to researchers and sources of monetary funding.

Description of Exemplary Systems and Methods

In an embodiment, systems and methods of the present disclosure may be applied to create an open system for the disclosure and development of technologies. In an embodiment, innovators and/or brands having technologies may disclose the technologies and save the disclosures on system components. In an embodiment, sources of monetary funding may view the disclosures of the technologies and decide to fund research and development of one or more technologies. In an embodiment, sources of monetary funding may include individuals, and the system may be operated in part as a crowdfunding platform. In an embodiment, the disclosures of the technologies may be formatted as grant applications or submissions in response to a request for proposals. In an embodiment, one or more researchers may access the disclosures of the technologies, the innovators, and/or the brands to collaborate in the development of the technologies. In an embodiment, the researchers may include one or more individuals having completed a doctoral degree (e.g., post-docs). In an embodiment, the collaboration of innovator(s), technologies, sources of monetary funding, and volunteer researchers may result in the generation of manuscripts. In an embodiment, one or more generated manuscripts may become a pre-peer reviewed article that may, in turn, be published by a scientific or technical journal.

As already described, systems and methods of the present disclosure may combine three elements: innovators, technologies developed by innovators, and sources of monetary funding. Systems and methods of the present disclosure may further include brands.

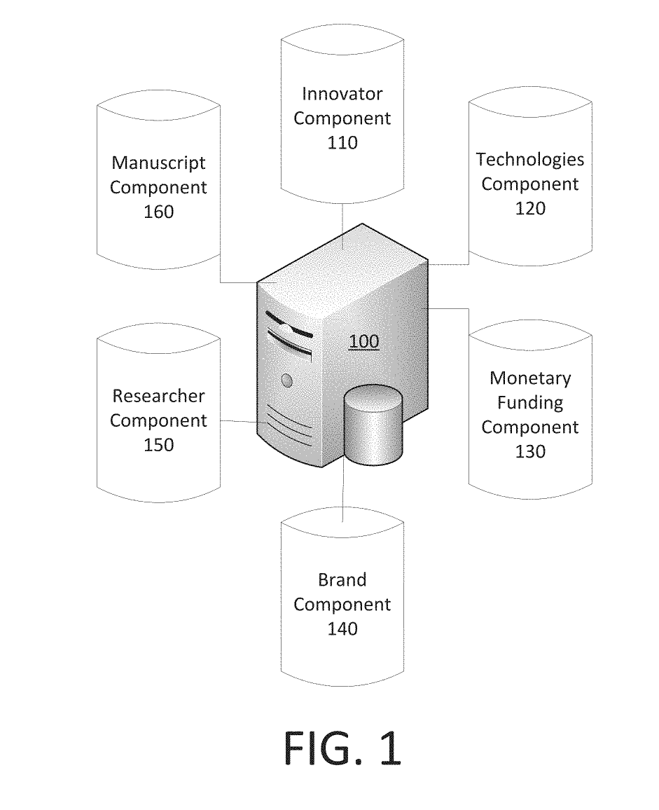

With reference to FIG. 1, in an embodiment, a network-enabled system may be provided. The network-enabled system may include one or more back-end servers 100. The back-end server(s) 100 may include innovator component(s) 110, technologies component(s) 120, monetary funding component(s) 130, and/or brand component(s) 140. Each component may reside on the same server(s) or different server(s). Multiple servers may be communicatively coupled together. Each component may store data corresponding to one or more elements of the system.

For example, the innovator component(s) 110 may store data related to one or more innovators. In an embodiment, the data related to innovator(s) may include basic demographic information, educational information, areas of past research, current research, areas of future research interest, and/or affiliations with a brand.

The technologies component(s) 120 may store data related to one or more technologies. In an embodiment, the data related to a given technology may include a description of the technology, short- and long-term goals for developing the technology, a description of potential uses of the technology, a description of the scientific or technical field(s) impacted by or applicable to the technology, and the like. The level of detail included in the data related to a given technology may range from a broad idea in one embodiment to enough detail to compile a grant application or respond to a request for proposals in another embodiment.

The monetary funding component(s) 130 may store data related to one or more sources of monetary funding. For example, in an embodiment, the data related to the source(s) of monetary funding may include the identity of the source(s) of monetary funding, any preliminary requirements needed to apply for funding, specific requests for proposals or grants directed to particular scientific or technical fields and/or specific research targets, more general goals and purposes of the source(s) of monetary funding, and similar information that may allow an applicant for funding, such as an innovator, to decide whether the source(s) of funding may be likely to consider funding the development of a technology or project seriously.

The brand component(s) 140 may include data related to one or more brand(s). In an embodiment, the data related to the brand(s) may include general information, areas of research activity, areas of interest for future research activity, significant past or present scientific or technical projects, and other similar information relevant to research and development.

In an embodiment, a back-end subsystem may access the back-end server(s) 100. The back-end subsystem may access, format, organize, and/or otherwise use data residing on the server(s) 100 to arrange the data for presentation on a user interface. Information in one component of a back-end server 100 may be associated with information in another component in a back-end server. For example, a technology may be associated with one or more of an innovator or brand who contributed or disclosed the technology to the system and/or one or more sources of monetary funding that committed funding for the development of the technology. The user interface may be accessible from the Internet. When the user interface is accessed, e.g., from a web browser, the information and data stored on the server(s) 100 may be displayed in an interactive format, allowing a user to view and interact with information related to the innovators, technologies, sources of monetary funding, and brands. In an embodiment, associations between technologies, innovators, brands, and/or sources of monetary funding may be informatively displayed by the user interface.

In an embodiment, each of the innovators (or other users), representatives of the sources of monetary funding, and representatives of the brands may interact, via the user interface, with the system to add and edit data to the back-end server(s) 100, as well as to interact with the information and data submitted by others. The user interface my include searchable and narrowing features to target (1) one type of user, e.g., a source of monetary funding or an innovator; (2) one area, category, or field of technology; (3) affiliation with a brand; and/or (4) other types of searches and filters to limit the number of results displayed to a user. In an embodiment, technologies may be classified or organized hierarchically, allowing a user may be able to search for technologies by progressively narrowing the scope. For example, a user may be able to browse the field of Medicine, which may include a subfield of Diseases, which may include a subfield of Cancer, which may include a subfield of Sarcomas, which may further include progressively narrower subfields. A technology may be classified under one or more subfields. In this manner, a source of monetary funding may be able to reach out to innovators in a targeted field of research, innovators can more efficiently target sources of monetary funding, brands looking for innovators with experience in a particular field of research or technology can reach out to those innovators, innovators looking to team up with innovators in a similar field can connect with each other, and the like. Through the user interface, a user may be able to read and analyze descriptions of the technologies, information related to the innovators, information related to the brands, and/or whether a technology has funding committed to the development of the technology and/or by whom. A user interface may be configured to grant some users permission to view more information stored on one or more components of the back-end server(s) 100 than other users. In an embodiment, the user interface may include a dashboard allowing a user to see a broad status overview of interested technologies. For example, a brand may be able to track the status of technologies with which it is associated (including, for example, the number and identity of researchers working on a manuscript, the number of manuscripts produced, the success of the technologies of a particular innovator, and the like). By accumulating and presenting information related to innovators, technologies, brands, and/or sources of monetary funding, the systems and methods of the present disclosure may promote transparency in and facilitate the funding of scientific and technical research and development.

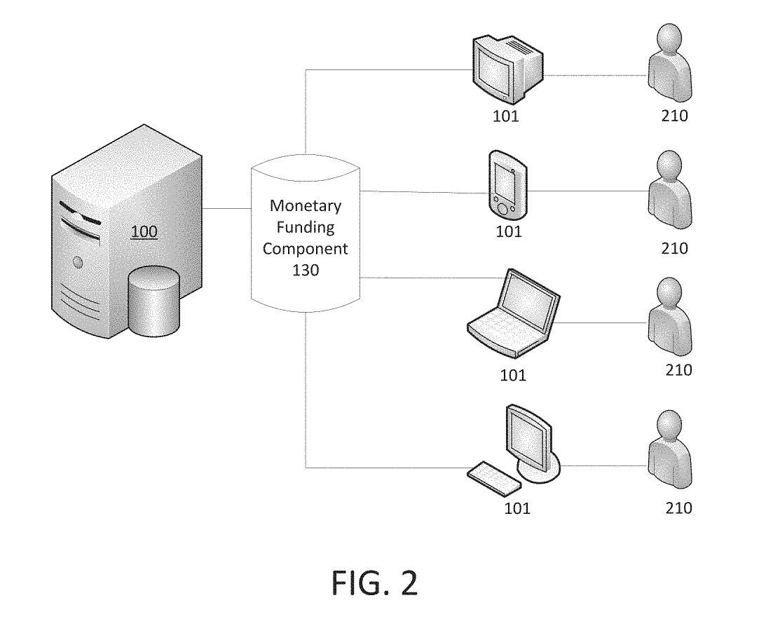

In an embodiment, the user interface may be configured as a crowdfunding platform. FIG. 2 illustrates one example of an embodiment that incorporates a crowdfunding platform. An exemplary user may be an interested individual 210, as opposed to an innovator, representative of a brand, or representative of a source of monetary funding having a large capital base. For example, an interested individual 210 may be an individual with an interest in a particular scientific or technical field wishing to donate a relatively small amount of money, such as $1, $5, $50, $100, etc., to further the development of a technology. A large number of small donations by interested individuals 210 may enable meaningful research to be funded. Interested individual(s) 210 may access the user interface by a computer, smartphone, or other Internet-enabled electronic device, such as any of electronic devices 101. The user interface may connect interested individual(s) 210 to a monetary funding component 130 of back-end server 100.

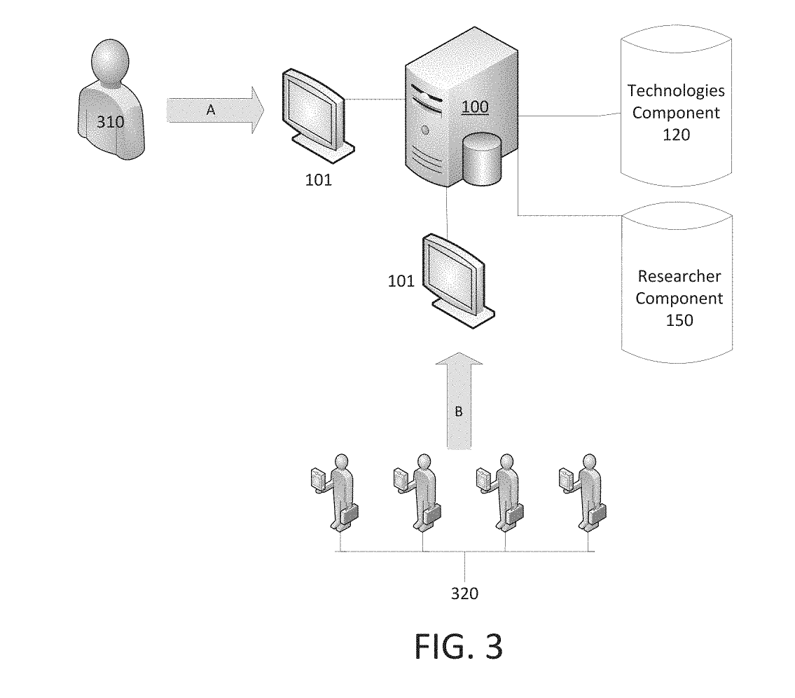

In an embodiment, with reference to FIG. 1 and FIG. 3, the back-end server(s) 100 may include one or more researcher component(s) 150. The researcher component(s) may store data related to one or more researchers 320. In an example, the data related to one or more researchers 320 may include basic demographic information, educational background information, thesis or dissertation information, manuscript or publication information, scientific or technical fields of interest, short-term and long-term career goals, and the like. In an embodiment, an innovator 310 may disclose information and data directed to a technology to a technologies component 120 of a back-end server 100 via a user interface accessed by a network-enabled electronic device 101. One or more researchers 320 may access the user interface via a network-enabled electronic device 101, disclose information and data related to the researcher 320 to a researcher component 150 of a back-end server 100, and make that information available for other users to the system, for example, innovators 310 and/or brands. Once a researcher 320 is connected to the system, researcher 320 may contact innovator 310 and vice versa. For example, researcher 320 may have disclosed information relating to previous research projects and experience or research areas of interest. An innovator 310 may utilize search features of the user interface to search for researchers 320 by area of interest or experience. Likewise, a researcher 320 may search for technologies in a particular field of interest or experience for researcher 320, identify an interesting technology, and contact innovator 310 who is associated with the technology in hopes of pursuing research directed to the technology, for example, research led by innovator 310.

A researcher 320, in this context, may refer to an individual with in interest in one or more scientific or technical fields and a willingness to personally contribute to the research and development of a technology in that scientific or technical field. Often, a researcher 320 may have educational training in the particular scientific or technical field or a related field. For example, a researcher 320 may have an undergraduate, graduate, or doctoral degree in his or her interested field. In an embodiment, a researcher 320 may not have completed educational training but may be in the process of doing so; such a researcher 320 may include an undergraduate student, a graduate student, or a doctoral student, for example. In some embodiments, a researcher 320 may include one or more high school students; for example, an advanced high school student could participate in research for a long-term school project, and/or a class could collectively participate in research as a researcher.

In an embodiment, a researcher 320 may be a post-doc (also known as a postdoctoral scholar or a postdoctoral researcher). Post-docs may often be under pressure to produce manuscripts based on research that may evolve into published journal articles. In some cases, attaining the status of an author on a published journal article may be a prerequisite to attaining meaningful employment. Accordingly, researchers 320, and post-docs in particular, may be incentivized to participate in research. The systems and methods of the present disclosure may provide mutual opportunities—opportunities for the researchers 320 to engage in research with innovators 310, some of whom may be well-known and highly published, and opportunities for the innovators to access a pool of motivated talent having an educational background and/or research experience in the field of an innovator's technology. Participating in research in the systems and methods of this disclosure may result in a more rapid production of manuscripts than is otherwise currently possible. Producing manuscripts with the potential to be published by a scientific or technical journal may be an important incentive for researchers 320 such as post-docs. An additional incentive for a researcher 320 may be the potential to collaborate on research with a highly published and prestigious innovator 310 in the same field as the researcher.

Systems and methods of the present disclosure may allow innovators 310 to collaborate with each other to further the development and research a given technology. In such an embodiment, an innovator 310 may disclose a technology by uploading a description of the technology to the technologies component 120 of a back-end server 100, for example as described above. One or more other innovators, for example by adjusting settings related to their own information or by separately registering as researchers 320, may participate in research with the disclosing innovator 310 to develop the technology. In an embodiment, a brand may own a number of technologies, only a small subset of which it is actively trying to protect or commercialize. A brand, for reasons discussed in this disclosure, may disclose a description of one or more of its more dormant technologies to the technologies component 120 of a back-end server 100.

Through the user interface, an innovator 310 or a brand looking for researchers 320 with which to collaborate on research and development, for example to develop a technology and/or to produce a manuscript and potentially a published, peer-reviewed article, may access the user interface and search for researchers 320 that are available, have an interest or experience in the field of the technology, and/or have a demonstrated work ethic and desire to actively engage in research. Other filtering features may be applied, for example a language filter to pair innovators or brands and researchers 320 who read, speak, and write in the same language. Through the user interface, a researcher 320 may search for an innovator 310, brand, or technology and submit a pitch to collaborate on a particular research and development effort. The user interface may enable interested innovators 310, researchers 320, brands, and sources of monetary funding to connect with each other in multiple ways, as will be appreciated by one of skill in the art.

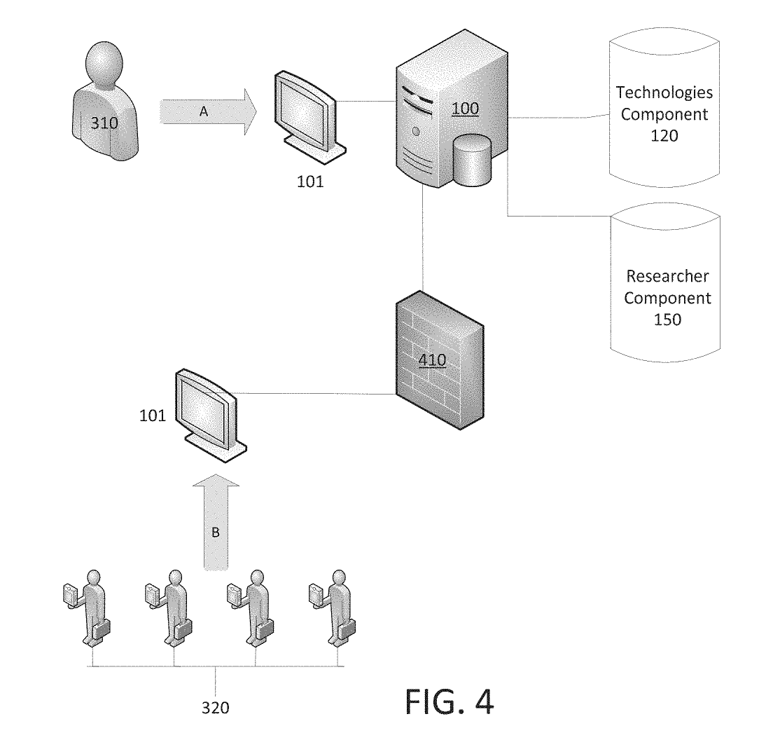

In an exemplary embodiment, for example with reference to FIG. 4, systems and methods described herein may further include one or more science community managers 410. A science community manager 410 may act as a firewall between one or more interested researchers 320 and an innovator 310 or brand. For example, if a particularly high-profile innovator 310 discloses a technology, that innovator 310 may, without any filter, receive an impractically large number of requests to participate in research to further the technology, as many researchers 320 may wish to conduct research with that innovator. Accordingly, a science community manager 410 may, in an embodiment, receive the requests from the researchers 320. The science community manager 410 may then filter only the most relevant requests to the innovator 310. In an embodiment, the science community manager 410 may be a senior scientist. In an embodiment, an electronic version of a science community manager 410 may be implemented as software. In this scenario, an innovator 310 may input a pre-determined series of criteria tailored to what the innovator 310 is looking for in collaborative researchers 320. Only requests from researchers 320 meeting the innovator's 310 criteria may then be passed to the innovator 310 in such an embodiment.

Exemplary Incentives for Participation

A number of incentives may converge to encourage each innovator and brand to bring technologies into the system and sources of monetary funding to bring funding opportunities into the system. Innovators may often have an intrinsic desire to proliferate science and new research into the world to enhance the body of human knowledge; this desire and potential for more quickly dispersing those ideas around the world may incentivize innovators to participate in the systems and methods described herein. Additionally, innovators may often be interested in producing works of authorship, such as manuscripts that may become articles published in scientific and technical journals. As will be described in greater detail, the systems and methods of the present disclosure may facilitate opportunities to create manuscripts that may eventually develop into published articles. An increased opportunity to develop publications, or to increase the number of publications where an innovator is a listed author, may lead to increased job success, especially where an innovator works at a university or research institution. As an example, a higher production of published journal articles may lead to increased visibility within a field, which may lead to higher citation rates and an increased ability to attract co-authors. The increased publication rate, visibility, and potentially citation rate may lead to a higher h-value for the innovator. Accordingly, innovators may be incentivized to contribute or disclose technologies to participate in the systems and methods described herein.

Likewise, brands may be incentivized to participate in systems and methods according to the present disclosure. To start, brands may employ innovators, and either as part of an internal culture contributed to by innovators or by intentionally aligning the brand's interests with those of its innovators to keep the innovators happy professionally, brands may be incentivized to contribute technologies to participate in the systems and methods described herein. This may be important, as brands may legally own the technologies developed by innovators through their course of employment. While a brand may legally own technologies and thus have the ability to control their development, it may still be incentivized to participate in the systems and methods described herein. For example, a changing legal landscape, particularly in patent law as applied to life sciences, may make the protection of life sciences-based technologies less likely, narrower, or otherwise less lucrative. Other of a brand's technologies may, for one reason or another, lie dormant or underexploited because of the priorities of the brand's limited resources, the unpredictability of a particular technology, or the lack of ability of the brand to commercialize the technology. Disclosing a technology, for example, on the technologies component of a back-end server to allow innovators and interested researchers to further the development of the technology may provide a viable alternative to publications involving that technology. An increase in publications concerning technologies contributed by a brand may raise the visibility and prestige of the brand itself and may increase the visibility, prestige, and/or h-factor of innovators employed by the brand, which in turn may increase the visibility and prestige of the brand itself. Accordingly, a brand may be incentivized to commit technologies it controls to the systems and methods disclosed herein.

Sources of monetary funding may also be incentivized to participate in systems and methods according to the present disclosure. Larger sources of monetary funding, where size may be measured by the size of the source entity or the amount of money contributed to any one project, such as grant-awarding organizations, governments, large charities, organizations issuing requests for proposals, foundations, and the like, may be inherently incentivized to contribute monetary funding to a particular research project, such as by an organizational goal or mission. Smaller sources of monetary funding, such as individuals (including interested individuals making up the “crowd” on a crowdfunding platform embodiment) may have wide ranging incentives to contribute monetary funding to a research project. For example, an individual may have been impacted by an event to which a technology is directed. In an example, an individual whose mother died from breast cancer may access the user interface, search for technologies directed to the diagnosis, treatment, or understanding of breast cancer, and choose to contribute even a small amount of monetary funding to the technology. In the aggregate, these funds can be significant. In another related example, the family of a woman who died from breast cancer may ask friends and family to donate small amounts of money to research and development of a technology disclosed by an innovator on an exemplary system and accessible to individual sources of monetary funding in lieu of flowers. Authors of a journal article may be ethically or otherwise bound to recognize contributors to the research and those who funded the research; accordingly, someone affected by an event may be memorialized in a scientific or technical publication directed to a technology related to the event. These incentives are exemplary, as sources of monetary funding, and individuals in particular, may be incentivized by a host of different things.

In an embodiment, a system according to the present disclosure may include one or more transparency-enhancing features. For example, it may be desirable for the sources of monetary funding or the amount of funding for a particular technology to be visible to users. Being associated with a technology as a source of monetary funding may stimulate a source of monetary funding to fund a technology. Additionally, a technology that has a promising level of funding may stimulate further funding. For example, a system according to the present disclosure may include one or more elements of blockchain technology. Blockchain technology may refer to a decentralized database network including a plurality of nodes that may sequentially record transactions on a public block to create a unique chain. A block may include a cryptographic hash of one or more records, including a timestamp and a link to or a hash corresponding to a previous block, thereby linking the two blocks. Each block may be encoded into a Merkle tree, and the iterative process of encoding authenticated new blocks onto the ledger may confirm the integrity of the previous block. A blockchain may be incorporated on a peer-to-peer network and may use a scoring algorithm to ensure that the highest scoring database is used (and that the same database is used by all peers selecting the highest scoring database). A transaction or record may be initiated by a user (e.g., a source of monetary funding) using a digital signature at a node. The transaction or record may be hashed and sent to one or more mining nodes through the network. The mining nodes may cryptographically authenticate the transaction along with other transactions and record the authenticated transactions on a block. When a block is completed, the mining node may broadcast the block to the network, building the chain. The size of the decentralized network and use of cryptographic proof-of-work may secure the blockchain ledger and thus the data recorded on the blockchain. Funding records of a particular technology may be recorded on a public blockchain ledger.

Researchers may also be incentivized to participate in systems and methods according to the present disclosure. Post-docs, for example, may often be under pressure to produce manuscripts based on research that may evolve into published journal articles; in some cases, attaining the status of an author on a published journal article may be a prerequisite to attaining meaningful employment. Accordingly, researchers in general, and post-docs in particular, may be incentivized to volunteer for and participate in research. Researchers may also be individuals having an inherent interest in a technology or a scientific or technical field, such as an individual with a collegiate degree in the field and a willingness to commit to a research project. These researchers may be inherently incentivized to participate in research. In an example, a researcher may be a student incentivized by a class or degree requirement. For example, in some universities, a scientific or technical undergraduate degree with honors may require the student to participate in research and produce a manuscript or a presentation.

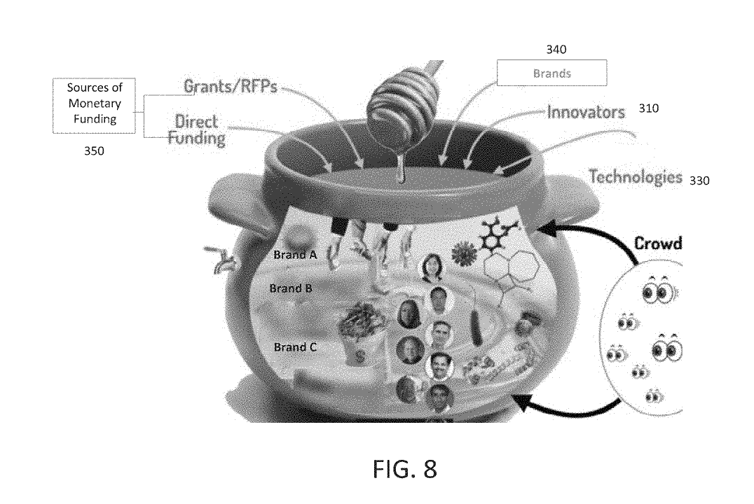

With reference to FIG. 8, an exemplary system according to an embodiment of the present disclosure may be conceptualized as a honey pot. One or more innovators 310, who may be associated with one or more brands 340, may disclose one or more technologies 330 to the system. Additionally, one or more sources of monetary funding 350 may also provide funds, including funds for research projects meeting certain criteria, for example. As described above, each of these entities may have motivations to participate in the system. The innovators 310, brands 340, technologies 330, and sources of monetary funding 350 may be conceptualized as the honey. Other users, including interested individuals 210 and researchers 320, may access the system to participate in research directed to a technology and/or to contribute monetary funding to one or more research projects and/or technologies. In an embodiment, these interested individuals 210 and researchers 320 may be considered to be part of the crowd in a crowdfunding platform. In particular, pairing researchers 320 with an innovator 310 and/or a brand 340 to conduct research to develop a technology 330, wherein such research is funded by sources of monetary funding 350, may produces direct a direct benefit to each participant, particularly when the research leads to a manuscript, as will be described in greater detail below. Accordingly, the system may take advantage of the incentives, for example as described herein, to produce a stickiness that encourages continued participation.

Generation of Manuscripts

In an embodiment, systems and methods of the present disclosure may result in the generation of manuscripts. A manuscript may refer to an article that describes and summarizes research, such as a particular research project, directed to a technology. Authors of manuscripts often write manuscripts with the hope that the manuscript will be published by a respected and well-disseminated journal. In some cases, a manuscript may be peer-reviewed, which may increase the chances of a journal publishing the manuscript. Manuscripts in scientific and technical writing may often follow a similar standard or pattern that highlights scientific methodology. In some cases, manuscripts may include sections for an abstract, an introduction, methods and materials, results, a conclusion, and/or a suggestion for future research. Different journals may have small variations on the specific order and content of manuscripts, and the order and content of a manuscript may have slight variations among scientific and technical fields. Manuscripts may include objectives of the research or experiments, whether the objections have been met, what if any changes to the protocol are necessary, whether the work has clinical or industrial applications, whether the statistical tests used are appropriate, whether the research or experiment has repeatable results, whether a search of the state of the art has been performed, and a summary of new findings.

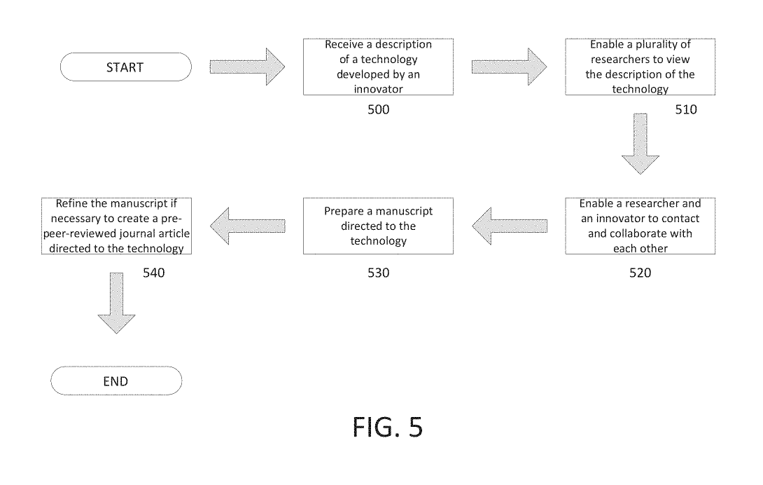

In an embodiment, an intended result from research and development efforts undertaken in accordance with systems and methods disclosed herein is the production of manuscripts. With reference to FIG. 5, for example, when an innovator and/or a brand discloses a technology 500 such that the technology is accessible to users 510 (e.g., other innovators, researchers, sources of monetary funding, brands, etc.) via the user interface, and an innovator and at least one researcher contact each other to collaborate on research directed to the technology 520, a result of the research and collaboration may include the preparation of a manuscript 530 directed to the technology and the research efforts to develop the technology. Additionally, the manuscript may be uploaded to a manuscript component 160 of back-end server 100, where it may be accessed by other innovators and/or researchers, who may refine the manuscript 540, for example, by proposing edits to the manuscript, proposing ideas to further the development of the technology, providing feedback on the research, collaborating in refining the manuscript, producing a second manuscript directed to the technology, and the like. In an embodiment, a draft version of a not-yet-completed manuscript may be saved to manuscript component 160. The draft version may be accessed by other researchers and/or innovators to refine the draft version of the manuscript, for example, as described above. Such a refinement process may result in the creation of a pre-peer-reviewed manuscript.

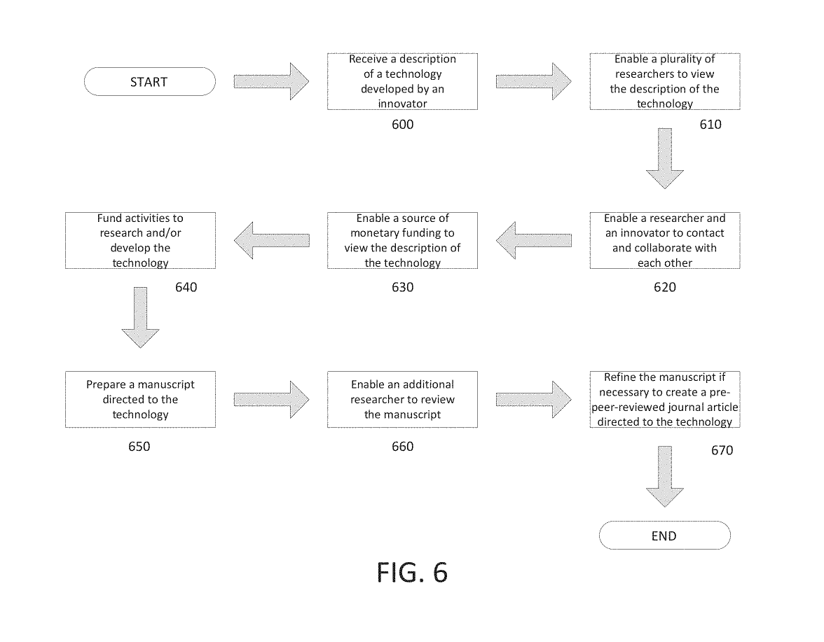

With reference to FIG. 6, for example, when an innovator and/or a brand discloses a technology 600 such that the technology is accessible to users 610 (e.g., other innovators, researchers, sources of monetary funding, brands, etc.) via the user interface, an innovator or brand and at least one researcher contact each other to collaborate on research directed to the technology 620, and a source of monetary funding views the description of the technology 630 and contributes funds that enable a research project directed to advancing the technology to occur 640, a result of the research project may be a manuscript 650. The manuscript may be uploaded to a manuscript component 160 of back-end server 100, where it may be accessed by other innovators and/or researchers 660, who may refine the manuscript 670, for example, by proposing edits to the manuscript, proposing ideas to further the development of the technology, providing feedback on the research, collaborating in refining the manuscript, producing a second manuscript directed to the technology, and the like. In an embodiment, a draft version of a not-yet-completed manuscript may be saved to manuscript component 160. The draft version may be accessed by other researchers and/or innovators to refine the draft version of the manuscript, for example, as described above. Such a refinement process 670 may result in the creation of a pre-peer-reviewed manuscript.

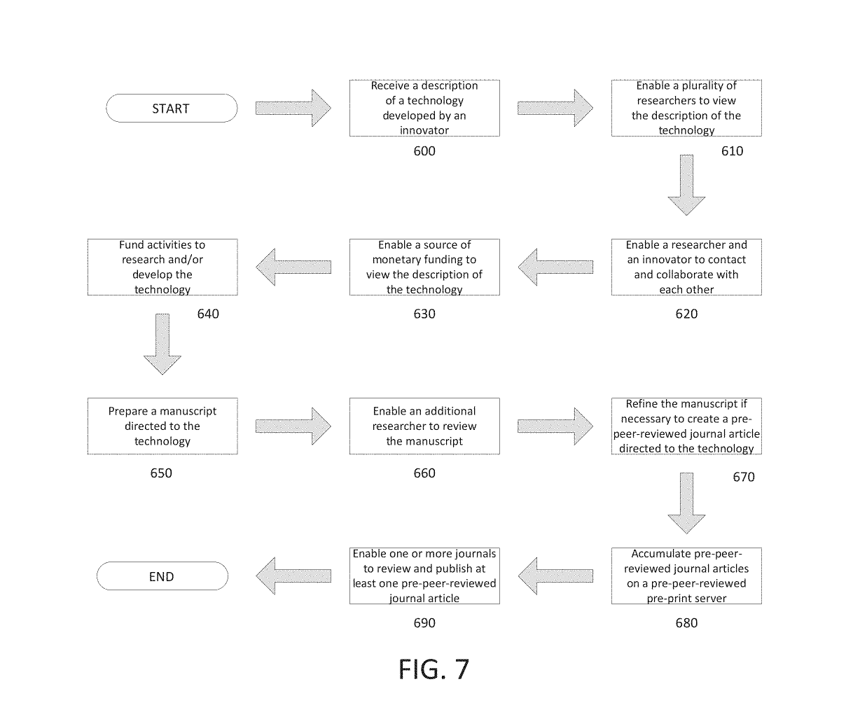

With reference to FIG. 7, systems and methods of the present disclosure may additionally accumulate a plurality of pre-peer-reviewed manuscripts on a manuscript component 160 (or other storage) 680. The storage holding a plurality of pre-peer-reviewed manuscripts may be called a pre-peer-reviewed pre-print server. Further, one or more scientific and/or technical journals may be able to access the pre-peer-reviewed pre-print server, select one or more pre-peer-reviewed manuscripts, and publish the manuscript 690. In an embodiment, a journal may access the pre-peer-reviewed pre-print server and/or select a manuscript for publication in exchange for a fee.

A manuscript may be customarily completed at the end of a research project in a given scientific or technical field. Indeed, the prospect of contributing to research described in a manuscript, with the corresponding potential to be an author in a published article, may often be an incentive to undertaking the research. As described above, the opportunity for a post-doc to collaborate on research with an innovator, particularly if the innovator is well established in his or her field, and generate a manuscript in connection with that innovator may significantly boost the career trajectory of the post-doc. Correspondingly, the opportunity for an innovator to have access to ready, enthusiastic, and relevant researchers may allow the innovator to complete more research projects and be named as an author on more manuscripts per year. The innovator's proliferation of research and h-value may increase as a result.

In an embodiment, many researchers may contribute to a research project, offering opportunities for a diverse range of views, suggestions for development, repetition, scientific rigor, and the like. In an embodiment, researchers on a single project may include researchers in different labs, parts of a country, or even researchers around the globe. In an embodiment, anywhere from two to several hundred researchers may participate in the research on the technology and/or in the preparation of a manuscript directed to that research.

In an embodiment, the production of manuscripts may occur as a transparent process. With reference to FIG. 1, in an exemplary embodiment, a back-end server 100 may include manuscript component(s) 160. Drafts of manuscripts, completed manuscripts, outlines of manuscripts, and other written works related to research may be uploaded to the manuscript component(s) 160. In an embodiment, researchers and/or an innovator may determine whether other users may see manuscripts in the drafting stage. In an embodiment, early drafts of a completed manuscript may be viewed by other users, i.e., users not directly involved in the subject of research for the manuscript. These users, which may include other innovators and researchers in the field of the technology to which the manuscript is directed, may review the manuscript and, in an embodiment, may provide comments, edits, suggestions to alter the methodologies or protocols, and/or additional interpretations of data. These other users may be considered peers for peer reviewing purposes. Accordingly, transparency in the production of scientific and technical manuscripts may be greatly enhanced.

In an embodiment, the generation of manuscripts may occur using wiki technology. In an embodiment using wiki technology, a manuscript may be drafted by a plurality of collaborators, such as researchers and/or innovators. Changes to a manuscript draft may be recorded in a log, which may identify the source of changes or the content of changes. The wiki technology may facilitate collaboration, particularly when the researchers or innovators are located remotely from each other, and the log may serve as a proof of work. For example, when a manuscript is finally drafted, a log will automatically be created that tracks all users or changes to the manuscript. If other users may view the manuscript during the drafting process or after an initial draft is created, the other users may use the wiki technology to suggest edits, comments, suggestions, and the like, as described above, and this activity may be recorded in the log. Additionally or alternatively, in an embodiment, drafts of or edits to a manuscript may be recorded on a secure public ledger using blockchain technology. For example, a blockchain address or public key may be associated with a particular user, and a record of the manuscript including comments or edits may be cryptographically hashed. The cryptographic hash may be used, for example, as a private key in a transaction or record, which may be stored on a blockchain ledger.

The increased transparency in the production of manuscripts and/or the collaboration of a plurality of researchers at varying stages of the research and production of the manuscript may lead to “pre-peer-reviewed manuscripts.” In other words, the scientific rigor that goes into a conventional peer-reviewed manuscript may take place organically during the development of a manuscript according to systems and methods of the present disclosure. Conventional manuscripts may be peer reviewed after the research has been completed and the manuscript has been edited and submitted. Typically, if a peer reviewer has significant criticism or other issues that might result in a less-than-optimal peer review, the researchers and innovator may need to revisit aspects of the research, tweak the protocol, rerun an experiment, and/or redraft the manuscript. In an unfavorable scenario, the research may need to be completely reformulated, repeated, and the manuscript redrafted and re-reviewed. This may result in a large delay and potentially a bar to publication. In a pre-peer-reviewed manuscript, however, flaws in methodology, technique, scope, and other issues that may hinder the likelihood of eventual publication may be identified while the research is being initially conducted. The innovator and researchers may make the appropriate corrections on-the-spot and continue with the research. At the end of the process, the innovator, the researchers, and/or a brand may be more confident in the rigor of the work and quality and significance of the results. Likewise, journal publishers may be more confident that the results reported in a manuscript are accurate and of high quality, enabling the publishers to confidently publish newer research on an accelerated timeline. This accelerated timeline from the performance of research to publication in a journal may in turn benefit the innovator and researchers, who benefit by a quicker publication. Quicker publication of new research may also benefit the scientific and technical communities as a whole by enabling more current research to be more quickly disseminated to interested scientists and technologists.

The organic generation of pre-peer-reviewed manuscripts may, in an embodiment of the present disclosure, lead to a new model for publishing quality scientific and technical articles. A component of a back-end server, such as the manuscript component or a finalized manuscript component, may store a plurality of pre-peer-reviewed manuscripts, each directed to a technology disclosed by an innovator and/or a brand, and further each manuscript describing research undertaken by an innovator in collaboration with one or more researchers. The pre-peer-reviewed manuscripts may optionally be made available to users and/or to the public. The server component that may store completed pre-peer-reviewed manuscripts may be referred to as a pre-peer-reviewed pre-print server. Like a conventional pre-print server, manuscripts posted thereon may be disseminated to an interested audience more expeditiously. Unlike a conventional pre-print server, however, the manuscripts may be pre-peer-reviewed and may be ready for publication by a journal, including a prestigious or high-impact journal. In an embodiment, an innovator, brand, and/or researchers involved in the preparation of a manuscript may desire to keep a particular manuscript private, i.e., not available to the general public, to preserve the ability to publish the manuscript as an article in a prestigious journal, particularly where the targeted journal has a strict dissemination policy.

Conventionally, each publisher has a specified format to which submissions for publication must adhere; the formats often differ from publisher to publisher. Additionally, many publishers require authors to agree to not submit a manuscript to another journal while being considered by the first journal or publisher, forcing the authors to wait for a decision on publication that may be favorable or unfavorable. Particularly when the manuscript is not chosen for publication, the author may have to start this process all over again. During this time, the science may stagnate, further reducing the likelihood of publication. The transparency and legitimacy inherent in creating a pre-peer-reviewed article, however, may create an incentive for the publishers to actively seek out pre-peer-reviewed articles for publication. Rather than focusing on peer reviewing manuscripts, a publisher may focus more on formatting and editing, thus removing this burden from the author. Accordingly, a pre-peer-review model may allow the author to draft a pre-peer-reviewed manuscript one time and solicit offers for publication. This may allow an author to begin work on another project.

In an embodiment, publishers of scientific or technical journals may have access to the pre-peer-reviewed pre-print server, for example, by paying a subscription fee. A publisher with such access may be able to browse the pre-peer-reviewed manuscripts or portions thereof, such as the abstracts, and may purchase the rights to publish a manuscript. A publisher may be more likely to purchase the rights to such a manuscript having knowledge of the rigor of the pre-peer-review process through which the manuscript was generated. Alternatively, in an embodiment, a publisher may be provided access to the pre-peer-reviewed pre-print server without a fee and may submit publication offers to the authors, who may control the rights to publication. Accordingly, the dynamic of scientific and technical publication may be reversed, with the publishers seeking out quality publications rather than passively receiving manuscripts of potentially dubious quality and/or relevance. This may create substantial efficiencies for both the authors of the manuscripts and the publishers. This may further lead to the more rapid dissemination of research. For example, it may be possible for the systems and methods disclosed herein to increase the manuscript generation rate of a moderately prolific innovator from about two per year to about twenty per year.

Industry Recommendations

In an embodiment, as a result of the implementation of systems and methods of the present disclosure over time, a large amount of data about a variety of users, including innovators, brands, researchers, and sources of monetary funding, may be generated and stored. Such data may be stored in one or more components of a back-end server. An entity engaged in research and development may wish to pursue research on a particular technology but lack the technical expertise and/or personnel to implement the research. This may be especially true for smaller entities without significant research budgets and/or for entities wishing to expand their current business lines. An entity may engage with an administrator of the system having access to user data to request recommendations for innovators and/or researchers that the entity can engage to undertake research for the entity. The administrator, given a technical field of interest and/or an intended technology, may be able to provide the entity with a targeted list of proven and relevant researchers and innovators. In an alternate embodiment, an entity interested in research may purchase access to the pre-peer-reviewed pre-print server to obtain manuscripts relevant to the entity's research goals.

Educational Curriculum

In an embodiment, as a result of the implementation of systems and methods of the present disclosure over time, manuscripts directed toward research to further the development of technologies may accumulate and be stored on one or more components of a back-end server, such as a manuscript component. In an embodiment, one or more manuscripts stored on a back-end server may be pre-peer-reviewed, and the back-end server may be a pre-print-reviewed pre-print server. In an example, a textbook publisher or publisher of other educational materials may purchase access to a manuscript component and/or a pre-print-reviewed pre-print server. With such access, a textbook publisher, for example, may access the most current results of research in a number of fields and could update textbooks with the most current and relevant information on a variety of topics. In this way, the results of scientific and technical research may be disseminated to students learning or training in a field. In an embodiment, a publisher may request updates on one or more specific topics, which may be directed to one or more technologies. A science community manager having familiarity with the system and most current research may provide updates, manuscripts, and the like in response to the publisher's request.

Grant Application Recycling and Refinement

Innovators and researchers may spend significant amounts of time outlining and drafting grant applications and responses to requests for proposals. While this time may ultimately be necessary to secure funding to pursue research and development of a technology, this is also time that could be spent performing research and development of a technology. Innovators and researchers may often prepare several grant applications for each research and development project they undertake to increase the likelihood that at least one source of monetary funding provides the requisite funds to undertake the research. In an embodiment, the information and data related to a technology stored on a technologies component may be in the form of a grant application or a response to a request for proposals. The information and data related to a technology may include enough detail to allow one or more sources of monetary funding to make a decision whether to fund particular research and development projects designed to further the development of the technology.

If a particular research project is not funded, in an embodiment, one or more other innovators and/or researchers may be able to view the information and data related to the technology to provide edits, suggestions, and/or alternative ideas to improve the likelihood that one or more sources of monetary funding may be willing to fund at least part of a research project. In an embodiment, the sources of monetary funding themselves may be able to suggest alternate protocols or slight changes to the scope of the project. If the innovator(s) and/or researcher(s) agree, the sources of monetary funding may be more likely to donate funds to the research and development project. In an embodiment, an innovator supplying a technology disclosure may be able to access information and data uploaded to a technologies component of a back-end server and use that information and data to compile and submit a grant application outside of the system, where the grant application may be substantially complete by virtue of the information and data having already been compiled and presented for sources of monetary funding to view and consider.

Exemplary Applications of the Systems and Methods

In an embodiment, systems and methods described herein may be adapted to facilitate a quicker response to unforeseen issues with the potential to affect people worldwide. For example, an extremely deadly disease may have an outbreak in a remote part of the world with the potential to spread quickly, as happened in late 2013 to early 2016 with the Ebola outbreak in West Africa. An individual on the ground, such as a doctor in a remote village, may treat a patient and suspect that the patient has a highly virulent disease with the potential to start an outbreak having local, national, regional, and/or international concern. The individual may access the user interface and upload a description of symptoms, photographs, patient medical data, and any information that might be relevant to medical researchers to a back-end server. In an embodiment, researchers may access the uploaded information and help the individual diagnose the patient. In an alternate embodiment, the individual may have made a diagnosis, and researchers may access the uploaded information to confirm the diagnosis and, if necessary, make proposals for research and development of medical techniques to aid in the treatment of the disease, such as treatment protocols and drugs. In an embodiment, a researcher, such as a well-known innovator connected with a prestigious brand and having access to a state-of-the-art research facility, may see the uploaded information, have an idea for promising research, draft a disclosure of an idea for a technology directed toward the treatment of the disease, and upload the disclosure to a technologies component of a back-end server. Research and development directed to the technology could then be organized and funded according to systems and methods previously described herein. In an embodiment, a science community manager, an individual associated with a governmental agency such as the United States Center for Disease Control, and/or an individual associated with an inter-governmental organization such as the United Nations may be able to highlight such a technology disclosure as high-priority, which may, for example, cause the technology disclosure to appear prominently when a user accesses the user interface. In an embodiment, if a technology disclosure is marked as high-priority, a source of monetary funding may see the high-priority technology disclosure first when accessing the user interface, potentially increasing the likelihood of the technology disclosure being funded. Such systems and methods may present advantages over conventional approaches to identifying and containing disease outbreaks. For example, many disease identifications and research ideas nay conventionally be identified and distributed to users subscribed to a list serv. Messages distributed on a list sery may be passed over by a user (e.g., due to volume of email messages), and each list sery may be directed only to a very specific field of users (e.g., medical researchers in infectious viruses). In contrast, uploading disclosures to a back-end server according to the present disclosure may allow an individual to reach a broader and more interested audience. For example, biochemists and scientists in other fields may have knowledge and research capabilities that may be applicable to developing a treatment for an infectious disease. The biochemist, for example, may be able to access the user interface and propose a technology that may be useful in treating the disease. Accordingly, doctors and patients in remote areas lacking state-of-the-art facilities may be connected to well-known innovators and researchers who have access to more advanced research capabilities, and a broader knowledge base may be accessed.

In an embodiment, systems and methods of the present disclosure may incorporate advanced artificial intelligence capabilities and related technologies, including machine learning and natural language processing. For example, an innovator with a threshold of interactions with the systems and methods described herein may develop a persona based on accumulated interactions that contribute language information, linguistic style information, sentence structure information, research interests, scientific and technical fields interests, needs and requirements, and the like. A persona, after a number of interactions, may become detailed and nuanced. Each user of the systems and methods described herein may develop a persona. The artificial intelligence and related capabilities may be able to match innovators, researchers, sources of monetary funding, and/or brands to each other based on each user's persona. For example, an oncologist with a persona may be paired with a microbiologist with a background in synthetic biology. The oncologist may have provided previous disclosures directed to the identification of certain essential proteins in tumors. The microbiologist may have prepared a manuscript directed to research in essential proteins in E. coli, where the essential proteins in the oncologist's disclosure and the microbiologist's manuscript have some degree of overlap. The oncologist and microbiologist may be placed in contact with one another to explore the potential of one's research to further the development of the other's research. In conventional scientific and technical research methods, these individuals may never have met due to the relatively insulated nature of many scientific and technical disciplines.

In an embodiment, systems and methods described herein may allow technologies disclosed in an exemplary system to be researched, developed, and brought to market. In an embodiment, one or more technologies may be directed to techniques and therapies with the same overarching goal, for example targeting melanoma with immunotherapy technologies. For example, one or more well-known innovators associated with a highly ranked brand may disclose one or more technologies, attract sufficient funding and researchers, and complete research resulting in pre-peer-reviewed manuscripts describing, for example, immunotherapy techniques to target melanoma in vivo and in vitro. Researchers using the exemplary system may be provided the manuscripts and other know-how for free, and the researchers may undertake further development efforts. In exchange for free access to the technologies, the researchers may commit to producing one or more manuscripts detailing their further development efforts and disclosing those manuscripts back to the system. In an embodiment, one or more researchers may leverage a technology described in a manuscript and establish clinical trial(s) in one or more jurisdictions. In an embodiment, a government may step in as a source of monetary funding to establish one or more clinical trials. In such an embodiment, in exchange for being provided access to the technology, the source of monetary funding may commit to share the clinical trial data back to the system. If, for example, multiple governments agree to sponsor multiple clinical trials and provide all the data back to the system, a vast record of clinical trial data may be accumulated and analyzed, which may contribute to future regulatory approvals with relatively little cost. Such clinical trial data may include data on more patients with a far larger amount of genetic and environmental diversity. Entities capable of manufacturing and/or otherwise commercializing the technology may then pay for access to the manuscripts, know-how, clinical trials data, and other information to develop treatments. These entities would not have the substantial research and development costs to recoup, which may be reflected in the price of the treatment. Furthermore, since no one entity would control the technology, several entities could produce competing products and/or treatments, driving down costs for patients and health care systems.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A method for facilitating the progression of science, comprising:
receiving a description of a technology developed at least in part by an innovator;
enabling a plurality of researchers to view the description of the technology;
enabling a first researcher from the plurality of researchers and the innovator to contact each other, wherein the innovator and the first researcher collaborate to produce a first manuscript directed to the technology; and
enabling one or more additional researchers to view the first manuscript and to take an action selected from the group comprising:
propose edits to the first manuscript;
propose ideas to further the development of the technology;
collaborate in refining the first manuscript; and
produce a second manuscript directed to the technology;
wherein a pre-peer reviewed journal article directed to the technology is produced.

2. The method according to claim 1, further comprising the step of submitting the pre-peer reviewed journal article to a journal for publication.

3. The method according to claim 1, further comprising the steps of:
enabling a money source to view the description of the technology; and
enabling the money source to provide the innovator with funding to develop the technology.

4. The method according to claim 3, wherein the money source is one selected from the group comprising a funder of a request for proposals, a grant, a foundation, a government, and an individual.

5. The method according to claim 1, wherein the innovator and at least one of the first researcher and the one or more additional researchers are named co-authors on the pre-peer reviewed journal article.

6. The method according to claim 2, wherein the journal purchases the pre-peer reviewed journal article for publication.

7. The method according to claim 1, wherein the innovator, first researcher, and one or more additional researchers interact with the manuscript using wiki technology.

8. The method according to claim 1, wherein the innovator, first researcher, and one or more additional researchers interact with the manuscript using blockchain technology.

9. A method for facilitating the progression of science, comprising:
receiving a plurality of descriptions of respective technologies, wherein each technology is developed at least in part by at least one of a plurality of innovators;
enabling a plurality of researchers to view the descriptions of respective technologies;
enabling a plurality of money sources to view the descriptions of respective technologies;
connecting one or more interested researchers from the plurality of researchers, each of the one or more interested researchers having an interest in a first technology, to a first innovator, the first innovator having developed at least a part of the first technology, to produce a first manuscript directed to the first technology;
connecting at least one money source to one of (a) the first innovator and (b) the first innovator and the one or more interested researchers, wherein the at least one money source provides funding to advance the development of the first technology;
enabling the plurality of researchers to view the first manuscript;
connecting one or more additional interested researchers from the plurality of researchers to one of (a) the first innovator, (b) the first innovator and the one or more interested researchers, and (c) the one or more interested researchers to take an action selected from the group comprising:
propose edits to the first manuscript;
propose ideas to further the development of the first technology;
collaborate in refining the first manuscript; and
produce a second manuscript directed to the first technology;
wherein a pre-peer reviewed journal article directed to the first technology is produced.

10. The method according to claim 9, further comprising the step of submitting the pre-peer reviewed journal article to a journal for publication.

11. The method according to claim 9,
wherein a plurality of money sources provide funding to advance the development of the first technology; and
wherein the at least one money source is one selected from the group comprising a funder of a request for proposals, a grant, a foundation, a government, and an individual.

12. The method according to claim 10, wherein the first innovator and at least one of the interested researchers are named co-authors on the pre-peer reviewed journal article.

13. The method according to claim 12, wherein the journal purchases the pre-peer reviewed journal article for publication.

14. The method according to claim 12,
wherein an entity from an industry related to the first technology has a need for expertise in the first technology; and
wherein the method further comprises the step of connecting the entity to one of (a) the first innovator, (b) the first innovator and the one or more interested researchers, and (c) the one or more interested researchers.

15. The method according to claim 9, further comprising the step of selling one of the first manuscript and the second manuscript to a textbook publisher.

16. The method according to claim 9, wherein the innovator, first researcher, and one or more additional researchers interact with the manuscript using wiki technology.

17. The method according to claim 9, wherein the innovator, first researcher, and one or more additional researchers interact with the manuscript using blockchain technology.
